(19) United States
(12) Patent Application Publication
(10) Pub. No.: US 2015/0146260 A1
(43) Pub. Date: May 28, 2015

(54) IMAGE FORMING APPARATUS, METHOD FOR CONTROLLING IMAGE FORMING APPARATUS, AND STORAGE MEDIUM

(71) Applicant: CANON KABUSHIKI KAISHA, Tokyo (JP)

(72) Inventor: Hanae Gabe, Yokohama-shi (JP)

(21) Appl. No.: 14/549,416

(22) Filed: Nov. 20, 2014

(30) Foreign Application Priority Data
Nov. 22, 2013 (JP) 2013-241667

(51) Int. Cl. G06F 3/12; G06K 15/00; G06K 15/02

(52) U.S. Cl. CPC G06F 3/1255; G06K 15/1889; G06K 15/1869; G06K 15/005; G06F 3/1256; G06F 3/1257; G06F 3/1258
USPC 358/1.18

(57) ABSTRACT

An image forming apparatus that reads an image of a document to perform image processing allows a page number to be printed at a user-desired position when an image, on which particular removal processing is performed, is to be printed. A method for controlling the image forming apparatus includes setting a print position of a page number to be printed on a sheet on which an image is to be printed, setting a removal position for performing particular removal processing on the image to be printed on the sheet, determining whether the set print position of the page number and the set removal position overlap each other, and providing notification of a change in the set print position of the page number if it is determined that the set print position of the page number and the set removal position overlap each other.

### BACKGROUND

1. Field

Aspects of the present invention generally relate to an image forming apparatus, a method for controlling the image forming apparatus, and a storage medium.

2. Description of the Related Art

In recent years, an image processing apparatus has been provided with a plurality of functions for performing image processing on only a particular specified area. These functions include a print function for stamps or page numbers, a frame removal function, and a binding margin function.

A conventional image processing apparatus allows a user to set a plurality of functions at the same time. However, when the same position is set for the page number print function and the frame removal function at the same time, a page number is printed in an area where an image has been blanked by the frame removal function, or a page number is printed in a position that has been moved from the intended position to prevent the page number from overlapping the frame removal area, for example. The desired output result differs from user to user. For example, some users desire to print the page number in the overlapping position. Other users desire to change the position of the page number to print it, or does not desire to change the position itself but desire to print the page number in a non-overlapping manner. Therefore, depending on the image processing apparatus, the user may not be able to obtain an output result intended by the user.

To address such an issue, some image processing apparatus has a function of excluding a particular combination of functions to prevent the user from setting the functions at the same time.

In addition, Japanese Patent Application Laid-Open No. 7-168818 discusses an image generation method in which, when the same image position is set for a plurality of image processing functions, the image processing apparatus automatically determines the state and changes the set position for page number print.

However, since the method discussed in Japanese Patent Application Laid-Open No. 7-168818 automatically changes the set position for page number print, the changed image may not result in an output the user actually desires. In addition, when the same position is set for a plurality of image processing functions at the same time, the method discussed in Japanese Patent Application Laid-Open No. 7-168818 always changes the position automatically. This means that the user who actually desires to output the result of a plurality of functions at the same position cannot obtain an expected result. These issues indicate that, if the image processing apparatus automatically determines to change the set position, a satisfactory result cannot be obtained because the user's intention is not fully reflected.

### SUMMARY

According to an aspect of the present invention, an image forming apparatus includes a first setting unit configured to set a print position of a page number to be printed on a sheet on which an image is to be printed, a second setting unit configured to set a removal position for performing particular removal processing on the image to be printed on the sheet, a determination unit configured to determine whether the print position of the page number and the removal position overlap each other, and a notification unit configured to, if the determination unit determines that the print position of the page number and the removal position overlap each other, provide notification of a change in the set print position of the page number.

Further features of the present disclosure will become apparent from the following description of exemplary embodiments with reference to the attached drawings.

### BRIEF DESCRIPTION OF THE DRAWINGS

FIG. 1 is a diagram illustrating a configuration of an image processing system.

FIG. 2 is a system block diagram illustrating a hardware configuration of a controller.

FIG. 3 is a flowchart illustrating a control method of an image forming apparatus.

FIGS. 4A and 4B are diagrams each illustrating an image processing state of an image processing apparatus.

FIG. 5 is a flowchart illustrating a control method of the image forming apparatus.

FIG. 6 is a flowchart illustrating a control method of the image forming apparatus.

FIGS. 7A and 7B are diagrams each illustrating an example of a user interface (UI) screen displayed on an operation unit.

FIG. 8 is a flowchart illustrating a control method of the image forming apparatus.

FIGS. 9A and 9B are diagrams each illustrating an example of the UI screen displayed on the operation unit.

FIGS. 10A and 10B are flowcharts each illustrating a control method of the image forming apparatus.

FIGS. 11A to 11C are diagrams each illustrating an example of the UI screen displayed on the operation unit.

### DESCRIPTION OF THE EMBODIMENTS

Various exemplary embodiments will be described in detail below with reference to the drawings.

### <Description of System Configuration>

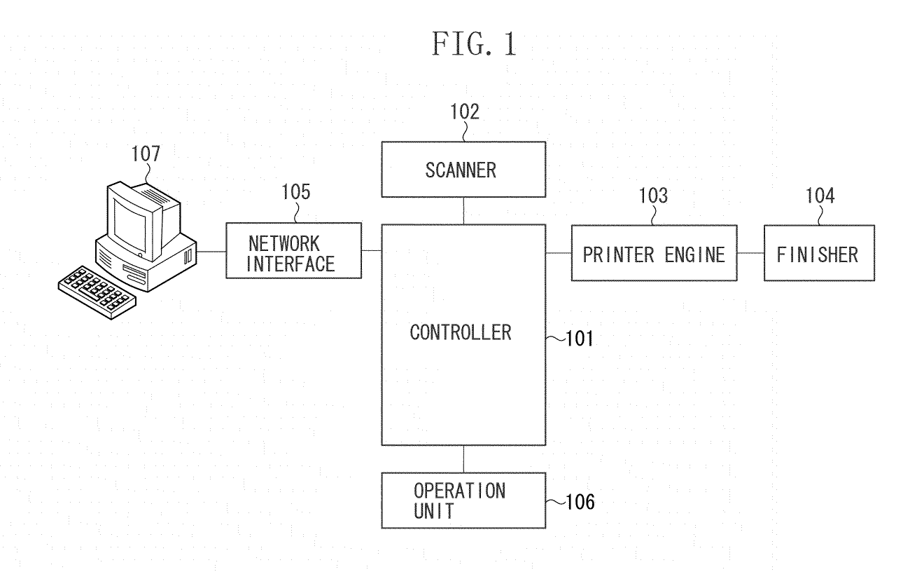

FIG. 1 is a diagram illustrating a configuration of an image processing system that includes an image processing apparatus according to an exemplary embodiment. This is an example of an image processing system to which a multi-function peripheral (MFP) is applied as an image processing apparatus. The components of this system will be described below.

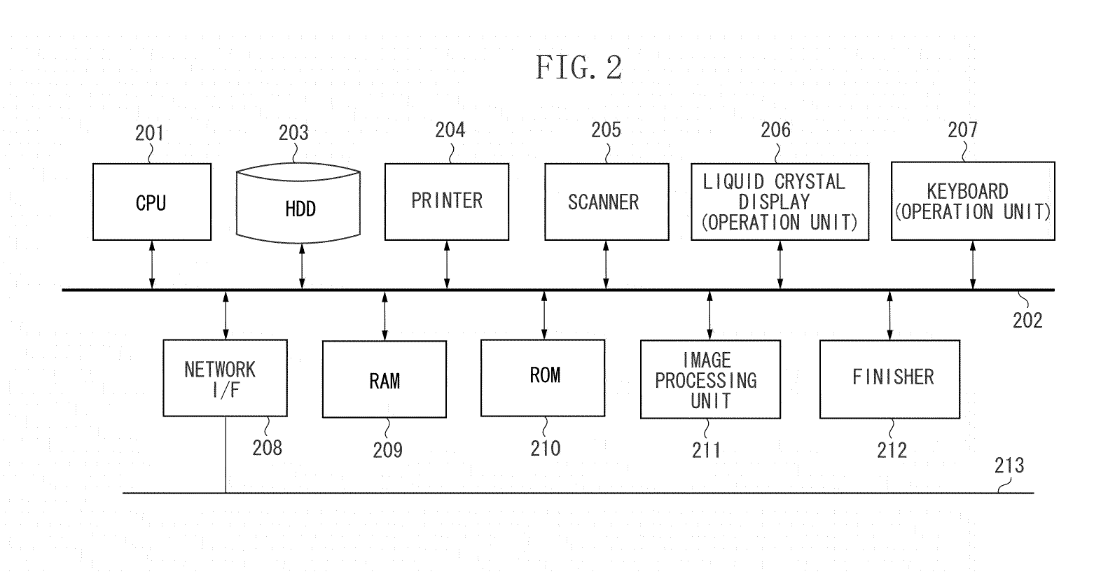

In FIG. 1, a controller 101, which controls the MFP, has a hardware configuration illustrated in FIG. 2. A scanner 102 is controlled by the controller 101.

A printer engine 103 is controlled by the controller 101. The printer engine 103 is connected to a finisher 104 that can perform staple processing on a plurality of recording media (e.g., a plurality of sheets of paper) output from the printer engine 103 at a time. The finisher 104 is controlled by the controller 101.

A network (Ethernet) interface 105 provides the controller 101 with two-way communication via the network interface 105. The network interface 105 allows the controller 101 to communicate with a personal computer 107 over a network.

An operation unit 106, which is a user interface, includes a liquid crystal display (LCD) and a keyboard. The operation unit 106 displays information received from the controller 101 and transmits an instruction from the user to the controller 101.

All functions are available for use via any interface of the network (e.g., Ethernet (registered trademark), Transmission Control Protocol/Internet Protocol (TCP/IP)).

FIG. 2 is a system block diagram illustrating a hardware configuration of the controller 101 illustrated in FIG. 1. In this example, the controller 101, which is connected to a network 213, includes a central processing unit (CPU) 201, a bus 202, a hard disk drive (HDD) 203, a printer 204, a scanner 205, and an LCD (operation unit) 206. In addition, the controller 101 includes a keyboard (operation unit) 207, a network interface (I/F) 208, a random access memory (RAM) 209, a read only memory (ROM) 210, an image processing unit 211, and a finisher 212. Each of the components will be described below.

In the controller 101, the CPU 201 loads a program, which is stored in the HDD 203 or the ROM 210, into the RAM 209 so as to control the entire operation of the MFP. In addition, via the bus 202, the CPU 201 communicates with the components of the MFP such as the LCD (operation unit) 206, the keyboard (operation unit) 207, the RAM 209, and the ROM 210.

The HDD 203, which is a hard disk drive including a hard disk, stores various types of input information. The printer 204, which is a printing device, corresponds to the printer engine 103 illustrated in FIG. 1. The printer 204 prints an image on a sheet based on input image data.

The scanner 205, which is a reading device, corresponds to the scanner 102 illustrated in FIG. 1. The scanner 205 reads the image of a document, which is placed by the user on a document positioning plate, as a color image and stores the image data thus obtained in the HDD 203 or the RAM 209. The scanner 205 may include a document feeding device to feed a plurality of documents, which is set in the document feeding device, sequentially onto the document positioning plate for reading.

The LCD (operation unit) 206, which is a display unit on which various types of information to be provided to the user are displayed, configures the operation unit 106 illustrated in FIG. 1. The LCD (operation unit) 206 has a touch panel sheet pasted on the liquid crystal to display the operation screen and soft keys of the system. When one of the displayed keys is pressed, the LCD (operation unit) 206 transmits position information of the key to the CPU 201.

The keyboard (operation unit) 207, which is composed of the keys used by the user to issue an instruction, configures the operation unit 106 illustrated in FIG. 1. The network I/F 208, which connects the MFP to the network 213, controls both the reception of data from an external device on the network and the transmission of data to an external device on the network. The image processing unit 211 performs image processing, such as zooming and color conversion, on image data accumulated in the RAM 209.

In the present exemplary embodiment, an example will be described in which the following two functions are set at the same time in an image processing apparatus having a plurality of image processing functions: one is a function to print a page number on each page (hereinafter referred to as a page number print function) and the other is a function to blank a specified area to be used as an area for binding (hereinafter referred to as a binding margin function). Particular removal processing included in the image processing according to the present exemplary embodiment includes frame removal processing and binding margin processing. The frame removal processing includes document frame removal processing, book frame removal processing, and punch hole removal processing.

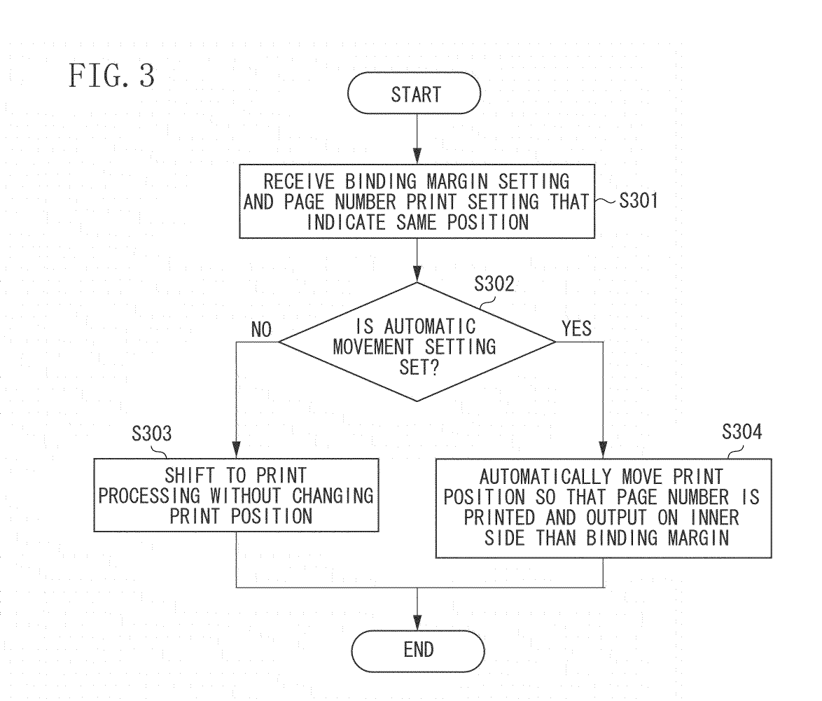

FIG. 3 is a flowchart illustrating a control method of the image forming apparatus according to the present exemplary embodiment. The flowchart illustrates an example of processing in which, when a page number print position and a binding margin position overlap each other, the page number print position is automatically adjusted. Each step of the processing is implemented by the CPU 201 that reads the control program, which is stored in the HDD 203 or the ROM 210, into the RAM 209 for execution.

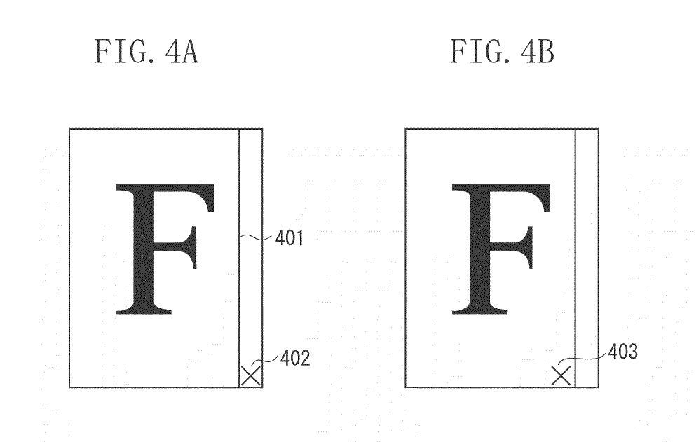

FIGS. 4A and 4B each illustrate an image processing state of the image processing apparatus according to the present exemplary embodiment. These are examples of an output produced by the processing illustrated in FIG. 3 in which the same position is set for the page number print position and the binding margin position.

First in step S301, the CPU 201 receives, from the operation unit 106 or the personal computer 107, settings specified by the user for the page number print function and the binding margin function, which indicate the same set position. In step S302, the CPU 201 determines whether an automatic movement setting is set in advance. If the CPU 201 determines that the automatic movement setting is not set (NO in step S302), the processing proceeds to step S303. If the CPU 201 determines that the automatic movement setting is set (YES in step S302), the processing proceeds to step S304.

In step S303, the CPU 201 moves directly to print processing without changing the setting. The output in this case is an image illustrated in FIG. 4A.

FIG. 4A illustrates an image in which a page number 402 is printed in a binding margin 401. This is because the position of the binding margin 401 set on the right side of the document and the position of the page number 402 set in the bottom right corner overlap each other.

In this case, however, the binding margin function may blank an image in the specified area after a page number is printed therein, causing the page number to be deleted, depending on the configuration of the apparatus.

On the other hand, in step S304, the CPU 201 automatically adjusts the set page number print position before the print processing is performed, so that the page number print position is set on the inner side than the binding margin. The output in this case is as illustrated in FIG. 4B. FIG. 4B illustrates a state where the position of a page number 403 has been moved to the inner side than the binding margin.

According to the present exemplary embodiment, when the same position is set for a plurality of functions, each of which performs image processing on a specified image area, a message for warning the setting state is displayed on the LCD (operation unit) 206 to allow the user to confirm the state. In addition, to print a page number that would be deleted under the current setting by particular removal processing, it is possible to receive a print position of the page number intended by the user. This configuration allows the user to print a page number in a user-intended position and also to print an image, on which particular removal processing is performed, on a sheet.

In addition, the present exemplary embodiment uses an automatic movement setting for moving a page number position automatically to a particular position. This enables the print position to be automatically corrected without asking the user to issue an instruction again.

In a second exemplary embodiment, an example will be described in which the following two functions are set at the same time in an image processing apparatus having a plurality of image processing functions: one is the page number print function and the other is a function to blank a black part that would be printed due to a shadow or a punch hole on a document (hereinafter referred to as a frame removal function).

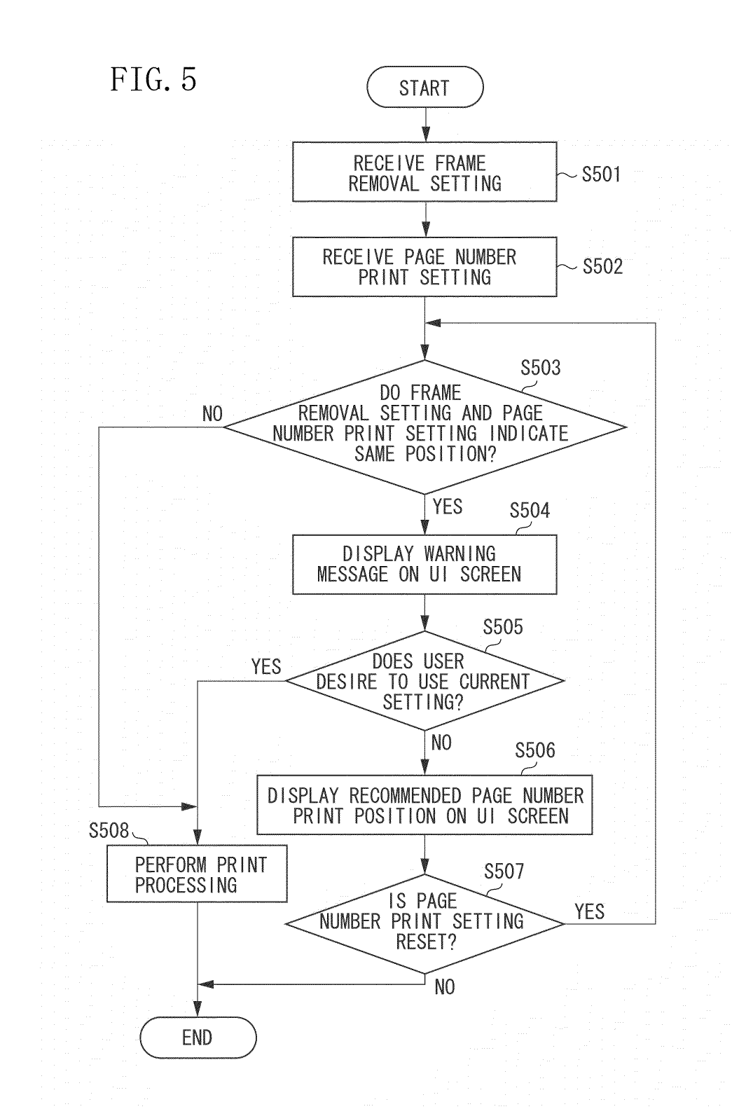

FIG. 5 is a flowchart illustrating a control method of the image forming apparatus according to the present exemplary embodiment. The flowchart illustrates an example of processing in which, when a page number print position and a frame removal position (deletion position) overlap each other, the user is requested to issue an instruction. In the present exemplary embodiment, it is assumed that the automatic movement setting described in the first exemplary embodiment is not set. Each step of the processing is implemented by the CPU 201 that reads the control program, which is stored in the HDD 203 or the ROM 210, into the RAM 209 for execution. The following describes the processing performed by the CPU 201 in which the CPU 201 first notifies the user that the position specified for particular removal processing and the print position of a page number overlap each other. Then, the CPU 201 receives an instruction from the user indicating a user-intended print position where the page number is to be printed without being deleted by the particular removal processing.

First, in step S501, the CPU 201 receives a frame removal setting specified by the user from the operation unit 106 or the personal computer 107. In step S502, the CPU 201 receives a page number print setting specified by the user from the operation unit 106 or the personal computer 107.

In step S503, the CPU 201 determines whether the set position received in step S501 and the set position received in step S502 overlap each other. If the CPU 201 determines that the set positions overlap each other (YES in step S503), the processing proceeds to step S504. If the CPU 201 determines that the set positions do not overlap each other (NO in step S503), the processing proceeds to step S508.

The processing in step S503 may be executed immediately after the CPU 201 receives the instruction in step S502 or after the CPU 201 receives a job start instruction from the user.

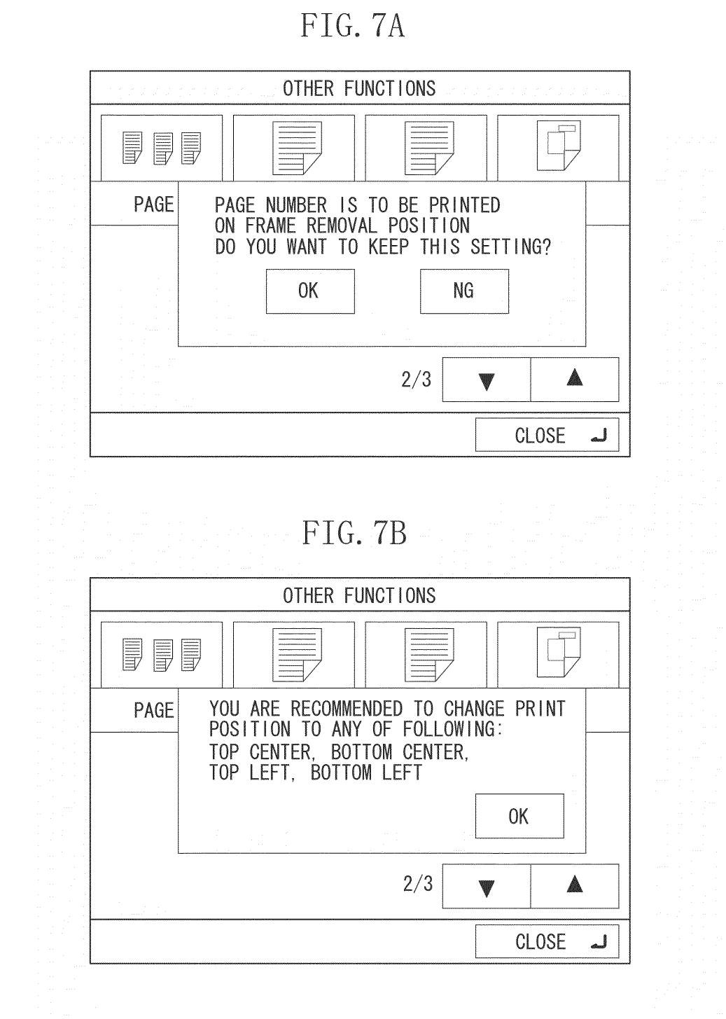

In step S504, the CPU 201 displays a warning message, which is illustrated in FIG. 7A, on the LCD (operation unit) 206 to notify the user that the set positions overlap each other.

In step S505, the CPU 201 receives an instruction from the user indicating whether the user desires to use the current set positions. If the CPU 201 determines that the user desires to use the current set positions (YES in step S505), the processing proceeds to step S508. If the CPU 201 determines that the user does not desire to use the current set positions (NO in step S505), the processing proceeds to step S506.

In step S506, the CPU 201 displays recommended print positions, each of which does not overlap the set frame removal position, on the LCD (operation unit) 206 as illustrated in FIG. 7B. FIG. 7B illustrates the print positions that are recommended when the right side of the document is set for both the frame removal function and the page number print function.

Next, in step S507, if the CPU 201 determines that the page number print setting reset by the user is received from the operation unit 106 or the personal computer 107 (YES in step S507), the processing proceeds to step S503. In step S508, the CPU 201 performs the print processing and terminates the processing in FIG. 5.

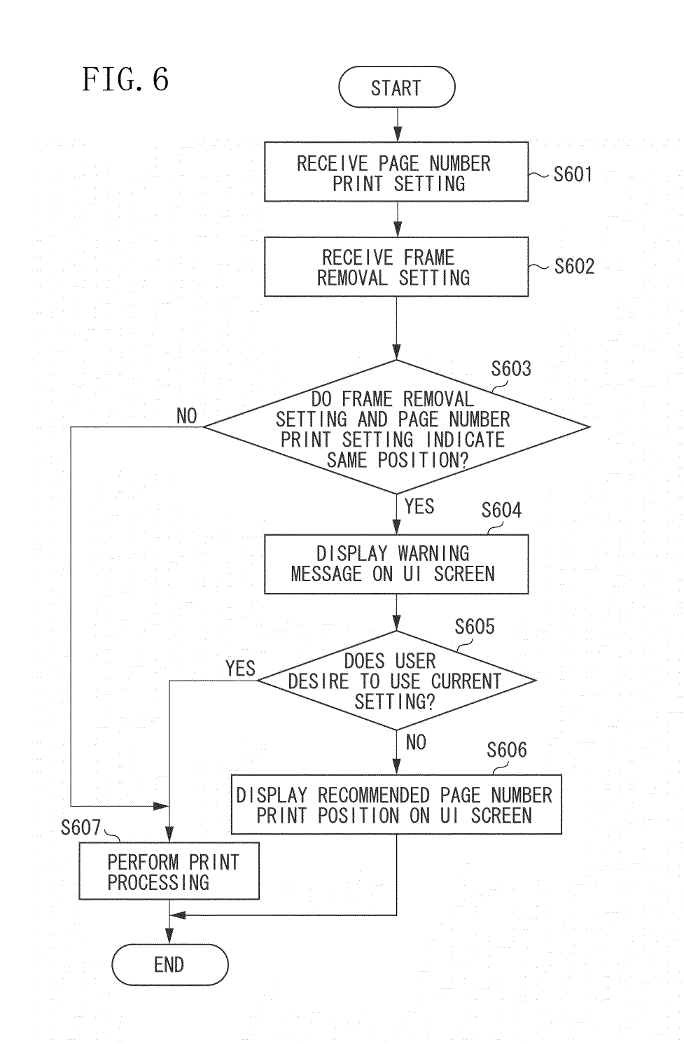

FIG. 6 is a flowchart illustrating a control method of the image forming apparatus according to the present exemplary embodiment. The flowchart illustrates an example of processing in which the setting order of the frame removal function and the page number print function is the reverse of that illustrated in FIG. 5. Each step of the processing is implemented by the CPU 201 that reads the control program, which is stored in the HDD 203 or the ROM 210, into the RAM 209 for execution.

In step 601, the CPU 201 receives a page number print setting specified by the user from the operation unit 106 or the personal computer 107. In step S602, the CPU 201 receives a frame removal setting specified by the user from the operation unit 106 or the personal computer 107.

Next, in step S603, the CPU 201 determines whether the set position received in step S601 and the set position received in step S602 overlap each other. If the CPU 201 determines that the set positions overlap each other (YES in step S603), the processing proceeds to step S604. If the CPU 201 determines that the set positions do not overlap each other (NO in step S603), the processing proceeds to step S607.

The processing in step S603 may be executed immediately after the CPU 201 receives the instruction in step S602 or after the CPU 201 receives a job start instruction from the user.

In step S604, the CPU 201 displays a warning message, which is illustrated in FIG. 7A, on the LCD (operation unit) 206 to indicate that the set positions overlap each other.

Next, in step S605, the CPU 201 receives an instruction from the user indicating whether the user desires to use the current set positions. If the CPU 201 receives an instruction indicating that the user desires to use the current set positions (YES in step S605), the processing proceeds to step S607. If the CPU 201 receives an instruction indicating that the user does not desire to use the current set positions (NO in step S605), the processing proceeds to step S606.

In step S606, the CPU 201 displays recommended print positions, each of which does not overlap the set frame removal position, on the LCD (operation unit) 206 as illustrated in FIG. 7B. Then, in step S607, the CPU 201 performs the print processing and terminates the processing in FIG. 6.

In a third exemplary embodiment, an example will be described in which a page number print function and a binding margin function are set at the same time in an image processing apparatus having a plurality of image processing functions.

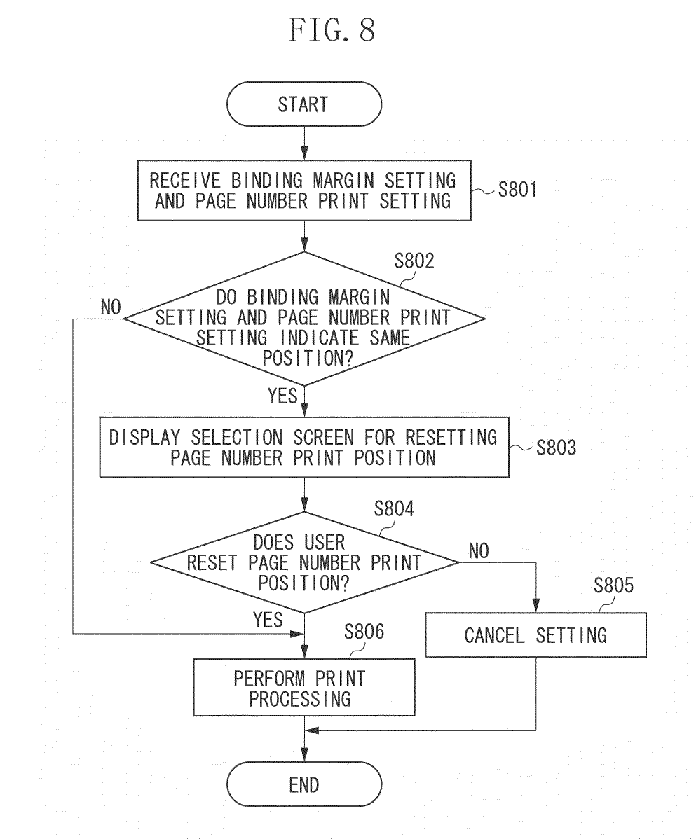

FIG. 8 is a flowchart illustrating a control method of the image forming apparatus according to the present exemplary embodiment. The flowchart illustrates an example of processing in which, when a page number print position and a binding margin position overlap each other, the user is always required to reset the print number position. Each step of the processing is implemented by the CPU 201 that reads the control program, which is stored in the HDD 203 or the ROM 210, into the RAM 209 for execution.

First, in step S801, the CPU 201 receives a binding margin setting and a page number print setting, both of which are specified by the user, from the operation unit 106 or the personal computer 107.

In step S802, the CPU 201 determines whether the set positions received in step S801 overlap each other. If the CPU 201 determines that the set positions overlap each other (YES in step S802), the processing proceeds to step S803. If the CPU 201 determines that the set positions do not overlap each other (NO in step S802), the processing proceeds to step S806. The processing in step S802 may be executed immediately after the CPU 201 receives the instruction in step S801 or after the CPU 201 receives a job start instruction from the user.

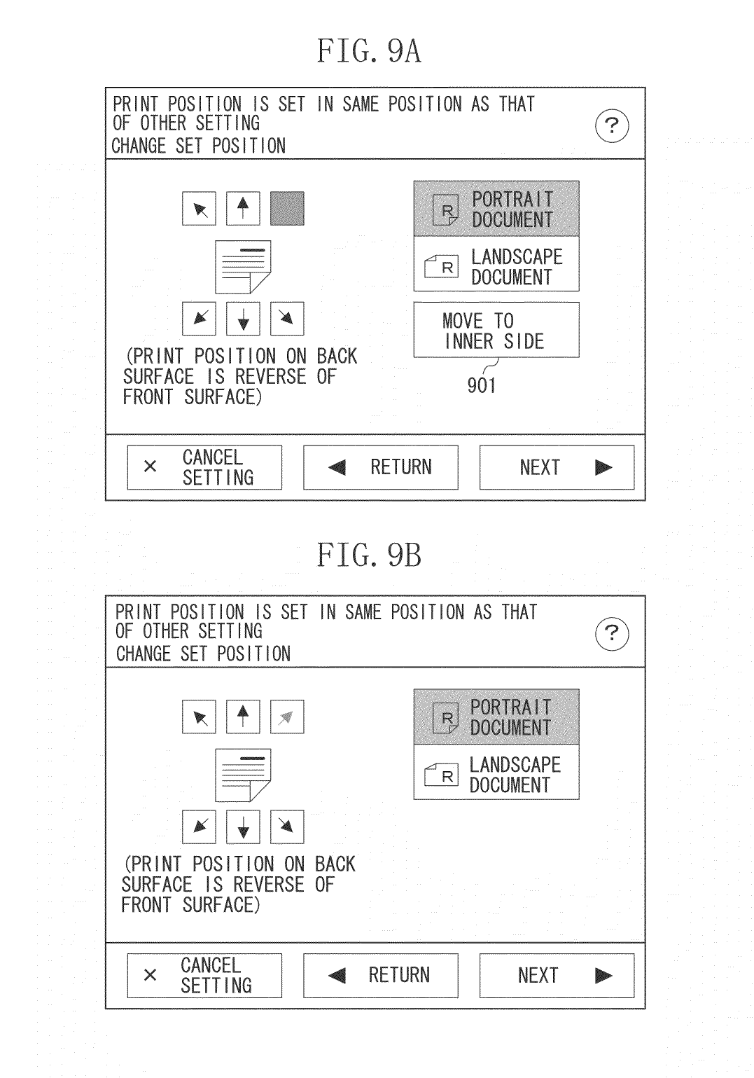

Next, in step S803, the CPU 201 displays a selection screen for resetting the page number print position such as those illustrated in FIGS. 9A and 9B.

At this time, it is possible to display a resetting screen, such as the one illustrated in FIG. 9A, on the LCD (operation unit) 206. On this screen, there is a button 901 for the function to move the print position to the inner side than the binding margin, which is described in the first exemplary embodiment. It is also possible to display a resetting screen, such as the one illustrated in FIG. 9B, that does not have a button for moving the print position to the inner side than the binding margin.

Next, in step S804, if the CPU 201 determines that an instruction for resetting the page number print position is received from the user (YES in step S804), the processing proceeds to step S806. If the CPU 201 determines that an instruction for resetting the page number print position is not received (NO in step S804), the processing proceeds to step S805. In step S805, the CPU 201 cancels the setting of the function specified later in step S801 or cancels both of the settings received in step S801 and terminates the processing in FIG. 8. On the other hand, in step S806, the CPU 201 performs the print processing and terminates the processing in FIG. 8.

In a fourth exemplary embodiment, an example will be described in which a combination of the page number print function, and the binding margin function or the frame removal function is set in an image processing apparatus having a plurality of image processing functions.

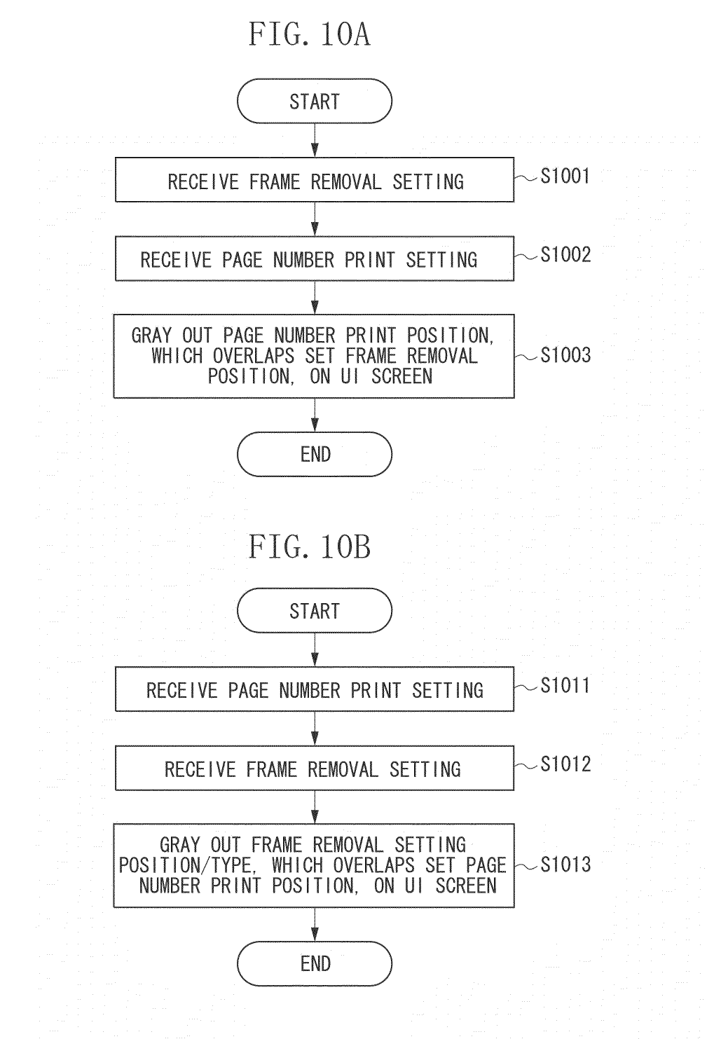

FIGS. 10A and 10B are flowcharts each illustrating a control method of the image forming apparatus according to the present exemplary embodiment. Each of the flowcharts illustrates an example of processing in which, when the page number print function and the frame removal function (or the binding margin function) are set, the page number print and the frame removal (or the binding margin) cannot be set in the same area. Each step of the processing is implemented by the CPU 201 that reads the control program, which is stored in the HDD 203 or the ROM 210, into the RAM 209 for execution.

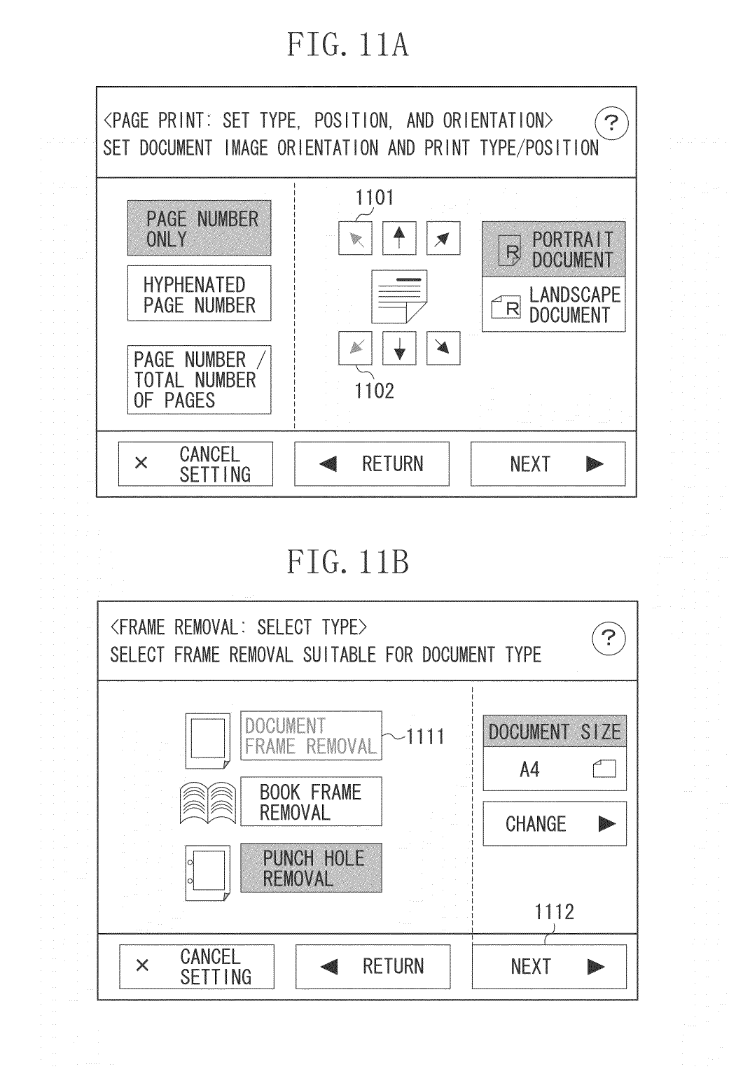

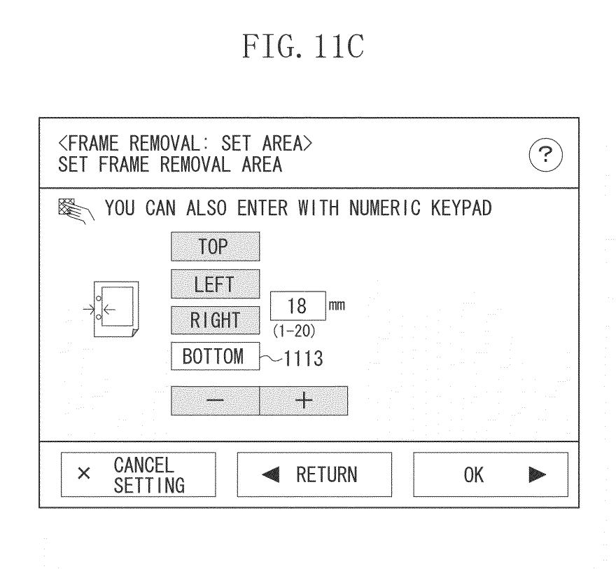

FIGS. 11A to 11C are diagrams illustrating examples of the UI screen displayed on the LCD (operation unit) 206 illustrated in FIG. 2.

FIG. 11A illustrates an example of the setting screen of the page number print function when the frame removal function is set only on the left half of an image in the image processing apparatus. FIGS. 11B and 11C each illustrate an example of the setting screen of the frame removal function when the page number print setting is set at the bottom of the document.

First, in step S1001, the CPU 201 receives a frame removal setting specified by the user from the operation unit 106 or the personal computer 107. In step S1002, the CPU 201 receives a page number print setting specified by the user from the operation unit 106 or the personal computer 107.

In step S1003, the CPU 201 displays a page number print setting screen on the LCD (operation unit) 206. On this screen, the page number print positions that overlap the frame removal position set in step S1001 are grayed out as indicated by buttons 1101 and 1102 in FIG. 11A.

In step S1011 in FIG. 10B, the CPU 201 receives a page number print setting specified by the user from the operation unit 106 or the personal computer 107. In step S1012, the CPU 201 receives a frame removal setting specified by the user from the operation unit 106 or the personal computer 107.

Next in step S1013, the CPU 201 displays a frame removal type selection screen on the LCD (operation unit) 206 as illustrated in FIG. 11B. On this screen, the frame removal type that overlaps the page number print position set in step S1011 is grayed out as indicated by a button 1111.

By pressing a NEXT button 1112 after selecting a frame removal type, the screen moves to a frame removal area setting screen illustrated in FIG. 11C. At this time, the CPU 201 displays the frame removal area setting screen on the LCD (operation unit) 206 in a state where a selection button 1113 corresponding to the frame removal position which overlaps the page number print position set in step S1011 is grayed out.

The exemplary embodiments provides a method for allowing, in a case where the print position of a page number overlaps the position set for particular removal processing, the user to print the page number in a desired position when an image is to be printed while performing the particular removal processing.

Additional embodiments can also be realized by a computer of a system or apparatus that reads out and executes computer executable instructions recorded on a storage medium (e.g., computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

This application claims the benefit of Japanese Patent Application No. 2013-241667 filed Nov. 22, 2013, which is hereby incorporated by reference herein in its entirety.

What is claimed is:

1. An image forming apparatus comprising:
a first setting unit configured to set a print position of a page number to be printed on a sheet on which an image is to be printed;
a second setting unit configured to set a removal position for performing particular removal processing on the image to be printed on the sheet;
a determination unit configured to determine whether the print position of the page number and the removal position overlap each other; and
a notification unit configured to, if the determination unit determines that the print position of the page number and the removal position overlap each other, provide notification of a change in the set print position of the page number.

2. The image forming apparatus according to claim 1, further comprising:
an image processing unit configured to perform the particular removal processing in the removal position on the image to be printed on the sheet;
a reception unit configured to receive a print position after the notification is provided, the print position being a position at which the page number is to be printed without being removed by the particular removal processing; and
a print unit configured to print on the sheet the image on which the particular removal processing has been performed and also to print the page number at the print position received by the reception unit.

3. The image forming apparatus according to claim 2, further comprising a reading unit configured to read an image of a document,
wherein the reception unit, based on an orientation of the image of the document to be read by the reading unit, does not receive a print position to be removed by the particular removal processing.

4. The image forming apparatus according to claim 1, wherein the particular removal processing includes frame removal processing and binding margin processing.

5. The image forming apparatus according to claim 4, wherein the frame removal processing includes document frame removal processing, book frame removal processing, and punch hole removal processing.

6. A method for controlling an image forming apparatus that reads an image of a document to perform image processing, the method comprising:
setting a print position of a page number to be printed on a sheet on which an image is to be printed;
setting a removal position for performing particular removal processing on the image to be printed on the sheet;
determining whether the set print position of the page number and the set removal position overlap each other; and
providing notification of a change in the set print position of the page number if it is determined that the set print position of the page number and the set removal position overlap each other.

7. A computer-readable storage medium storing computer executable instructions for causing a computer to execute a method for controlling an image forming apparatus that reads an image of a document to perform image processing, the method comprising:
setting a print position of a page number to be printed on a sheet on which an image is to be printed;
setting a removal position for performing particular removal processing on the image to be printed on the sheet;
determining whether the set print position of the page number and the set removal position overlap each other; and
providing notification of a change in the set print position of the page number if it is determined that the set print position of the page number and the set removal position overlap each other.
